(19) United States
(12) Patent Application Publication
(10) Pub. No.: US 2019/0146110 A1
(43) Pub. Date: May 16, 2019

(54) METHOD FOR TIME DRIFT MEASUREMENT, SEISMIC NODE AND SEISMIC NODE HANDLING SYSTEM

(71) Applicant: inApril AS, Oslo (NO)

(72) Inventors: Vidar HOVLAND, Hagan (NO); Terje SPARENGEN, Kolbotn (NO)

(21) Appl. No.: 16/307,083

(22) PCT Filed: Jun. 1, 2017
(86) PCT No.: PCT/NO2017/050141

§ 371 Date: Dec. 4, 2018

(30) Foreign Application Priority Data
Jun. 6, 2016 (NO) 20160971

(51) Int. Cl. G01V 1/36; G01V 1/18; G01V 1/38; G01V 1/24

(52) U.S. Cl. CPC G01V 1/362; G01V 1/18; G01V 2200/12; G01V 1/247; G01V 1/3852

(57) ABSTRACT

Method for time drift measurement of at least one slave clock in at least one seismic node, wherein the time drift measurement is performed in the at least one seismic node. The seismic node is configured for receiving a master clock signal and obtaining a time drift between the slave clock and the master clock signal.

The present invention concerns a method for time drift measurement in a seismic node, a seismic node and a seismic node handling system.

### BACKGROUND

Seismic surveying may be performed using a number of different solutions. Example solutions are e.g. seismic streamer cables towed behind a vessel, ocean bottom seismic cables, or autonomous seismic recorders/nodes arranged on the ocean bottom. The autonomous seismic recorders may be individually placed on the ocean bottom be e.g. remotely operated vehicles (ROV), by dropping the autonomous seismic recorders into the sea from a vessel, or alternatively the autonomous seismic nodes may be arranged on the ocean bottom attached to a cable deployed from the vessel. The cable may be a rope or a wire. The autonomous seismic nodes may be recovered attached to the cable, picked up by an ROV or picked up from the sea after floating to the surface.

Autonomous seismic nodes are independent seismic recorders that are able to operate on their own while on the sea floor. Autonomous seismic nodes typically comprises a housing with sensors (geophones and hydrophones), a data recording device and a power source. Autonomous seismic nodes are thus self-contained and do not need to be connected to anything nor communicate with anyone when positioned on the sea floor. When hereafter referring to seismic nodes, these are autonomous seismic nodes as explained above.

Each seismic node contains a slave clock providing a reference time for the various sensor data recorded by the node. Before placement on the seabed the slave clock in each seismic node is calibrated and synchronized with a master clock on the vessel for the same absolute time reference. The slave clocks in the nodes may drift during the time the seismic nodes spend on the seabed. This drift is often referred to as a combination of an ageing effect and other effects coming from temperature change etc. The time drift while on the seabed is measured when the nodes are onboard the vessel again. The data recorded while the node has been on the seabed is afterwards often corrected for the time drift based on some kind of drift assumptions.

After recovery of the seismic nodes from the seabed, the slave clock in each seismic node is therefore again compared with the vessel master clock and a clock drift, Δt, of each slave clock is measured and recorded. The slave clock drift, Δtᵢ, for the slave clock of each seismic node i (i=1 . . . n; where n is the number of nodes) is used to correct the time of reference of the recorded sensor data for this particular node, ensuring that all the seismic data recorded by all the seismic nodes are assigned as near as possible to the same time of reference which by definition is the vessel master clock.

The systems used today for slave clock drift measurement have a practical limitation in how many slave clocks that can be practically connected at the same time. The systems thus have a limitation in how many slave clocks that can be calibrated and synchronized at the same time before deployment, and have likewise a limitation in how many slave clocks that may be connected for time drift measurement at the same time after recovery from the seabed. Calibration and synchronization of the slave clocks in the seismic nodes may therefore in the prior art node handling systems also be performed in a separate location rather than in the storage location of the seismic nodes. Before deployment, each seismic node may be transported to a clock synchronization and calibration station for connection to the master clock. After recovery and before reaching its final storage position in e.g. a container, a node storage area or a node rack, each seismic node is again transported past a station for clock drift measurement, and connected directly or indirectly to the master clock for measuring and recording of the slave clock drift. The measurement of time drift is performed in the master clock or in a separate time drift measurement device separate from the seismic node and the master clock. This station for clock drift measurement might be the same as the clock synchronization and calibration station used during deployment. When the clock drift has been recorded, the seismic node is transported to its assigned storage position. Calibration, synchronization and recording of clock drift with the prior art solutions is time consuming and inefficient, in particular when taking into account that more than 10.000 seismic nodes may be used in a seismic survey. There is a need for more efficient seismic surveying including more efficient handling of the seismic nodes, reducing the time and costs involved.

### SUMMARY OF THE INVENTION

The invention solves or at least alleviate the problems outlined above.

In a first aspect the invention provides a method for time drift measurement of at least one slave clock in at least one seismic node, wherein the time drift measurement is performed within the at least one seismic node.

The method may further comprise receiving a master clock signal in each seismic node, and obtaining in each seismic node the time drift between the slave clock and the received master clock signal. The obtained time drift may be transmitted from each seismic node and to a computer or data management system. The time drift may be transmitted over a cable, an optical fibre, or wirelessly. The time drift measurement may be performed in the at least one slave clock in the seismic node, in a processor in the seismic node or in a hardware and/or software component in the seismic node. The time drift may be measured when the seismic node is in a storage position. The recorded data in the seismic node may be corrected for time drift before or during downloading of the recorded data from the seismic node and to a central computer. The master clock signal and the slave clock signal may be time synchronization signals.

In a further embodiment the invention provides a seismic node comprising a slave clock, wherein the seismic node is configured for receiving a master clock signal and obtaining a time drift between the slave clock and the master clock signal. The seismic node may further comprise a clock signal comparator for obtaining the time drift between the slave clock and the master clock signal. The clock signal comparator may be hardware and/or software. The clock signal comparator may be included in the slave clock. A connector may be provided in a seismic node interface for at least one of power transmission, communication signals, data transmission, the master clock signal and a measured time drift signal. The seismic node may further comprise a transceiver/transmitter for transmitting the measured time drift to a central computer or a data management system. The measured time drift may be transmitted via a cable, a fibre optic cable or a wireless transmission. The wireless transmission may comprise at least one of optical transmission, radio broadcasting transmission, or RF transmission.

In a further aspect, the invention provide a handling system for seismic nodes, s comprising a master clock, and wherein a time drift between a slave clock in a seismic node and the master clock is obtained by a time drift measurement internally in each seismic node.

Handling system may further include a communication line for transmitting a master clock signal to each seismic node. The communication line may comprise repeaters and/or drivers for the master clock signal. The handling system may comprise a seismic node storage system comprising a plurality of storage positions for the seismic nodes, and wherein the time drift in a seismic node is measured when the seismic node is in a storage position.

At least one of a signal repeater and a driver may be assigned to each seismic node storage position or a group of seismic node storage positions. Each seismic node may comprise a connector providing a seismic node interface for at least one of power transmission, communication signals, data signals, a master clock signal and a time drift signal. Further, each seismic node storage position may be provided with a docking connector for connecting to the connector on the seismic node. The measured time drift may be transmitted from each seismic node and to a central computer or a data management system through a communication line. The recorded data in the seismic nodes may be corrected for time drift before or during downloading of the recorded data from the seismic nodes and to a central computer or a data management system or later during processing of the data. The communication line may be a cable based communication line, a fibre optic based communication line or a wireless transmission.

The invention provides an efficient handling of the seismic nodes, considerably reducing the time as the seismic nodes may be transported directly to their assigned storage position in the node storage system. The solution provides a simplification of the node handling avoiding the need of particularly assigned synchronization/time drift stations, and reducing the number of communication lines between the node storage positions and the central control modules as the measurement of slave clock drift may be performed in storage positions of the seismic node. The seismic nodes are also simplified as a separate output for the slave clock synchronization signal to the master clock or an external system for slave clock drift measurement is avoided. Efficient handling systems for the nodes and simplification of the system considerably reduces the costs involved.

### BRIEF DESCRIPTION OF DRAWINGS

Example embodiments of the invention will now be described with reference to the followings drawings, where:

FIG. 1 illustrates calibration and synchronisation of a seismic node slave clock to a master clock;

FIGS. 2a and 2b illustrates time drift measurement of a seismic node slave clock on recovery of the seismic node, according to prior art;

FIG. 3 illustrates a time drift measurement of a seismic node slave clock according to an embodiment of the invention;

FIG. 4 illustrates time drift measurement of seismic nodes in a node storage system according to an embodiment of the invention;

FIGS. 5a and 5b illustrates a seismic node according to embodiments of the invention; and

FIG. 6 illustrates a seismic node handling system configured for time drift measurement of seismic nodes according to an embodiment of the invention.

### DETAILED DESCRIPTION

The present invention will be described with reference to the drawings. The same reference numerals are used for the same or similar features in all the drawings and throughout the description.

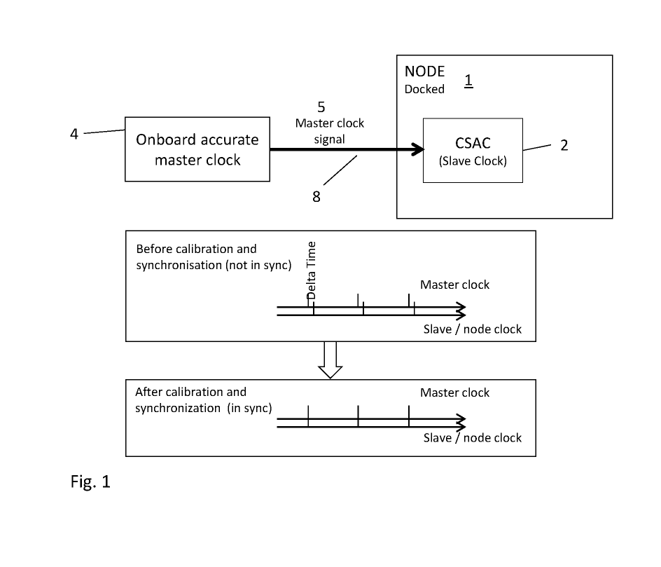

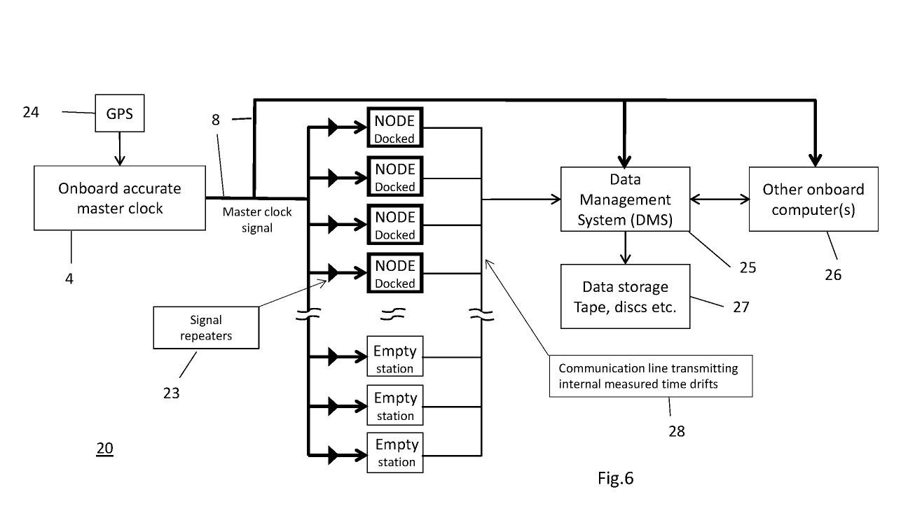

FIG. 1 illustrates calibration and synchronization of an internal seismic node slave clock 2 according to prior art. A vessel master clock 4 transmits a master clock synchronization signal 5 to the seismic node 1. The vessel master clock is a highly accurate precision clock. The precision clock may e.g. be an atomic clock or a high precision oscillator that may be calibrated and synchronized with satellite systems (e.g. GPS 24, FIG. 6). The slave clock in FIG. 1 is a Chip Scale Atomic Clock (CSAC), but other precision clocks may be used. Calibration of the internal seismic node slave clock 2 is performed internally in the seismic node 1 or in the slave clock 2 itself. Any deviations, delta time and accuracy, (before calibration) between the time synchronization signal or pulses 5 of the master clock and the time synchronization signal or pulses 3 of the seismic node slave clock 2, are corrected during the calibration and synchronization procedure. The slave clock 2 in the seismic node 1 will then, after the calibration procedure, be calibrated and synchronized with the master clock 4. As illustrated in FIG. 1, after calibration and synchronization the seismic node slave clock time synchronization pulses 3 are aligned with the master clock time synchronization pulses 5; i.e. the master clock time synchronization pulses are in sync with seismic node slave clock time synchronization pulses. When the slave clock 2 has been calibrated, a flag set in the seismic node slave clock or another signal confirms that the slave clock is calibrated and synchronised. The seismic nodes 1 are hence deployed with slave clocks 2 that are close to calibrated and synchronized with the master clock 4 on the vessel.

Standard procedure in the prior art solutions is to connect each of the seismic nodes 1 directly or indirectly to the vessel master clock 4 for calibration and synchronization just before deployment of the seismic nodes, and to connect each of the seismic nodes 1 again on recovery from the sea to the vessel master clock to measure the time drift Δtᵢ.

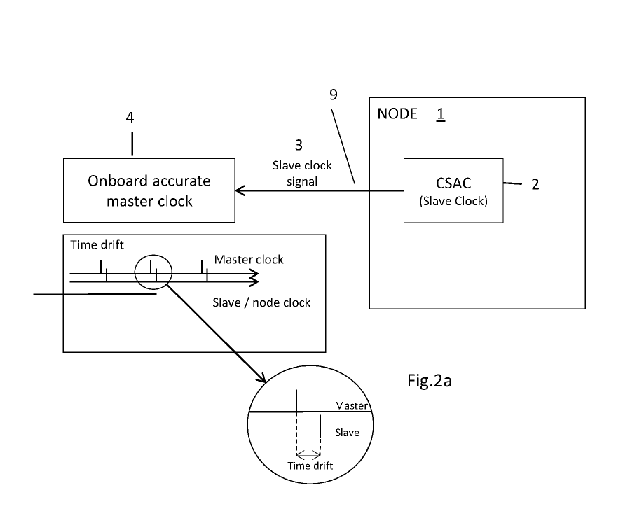

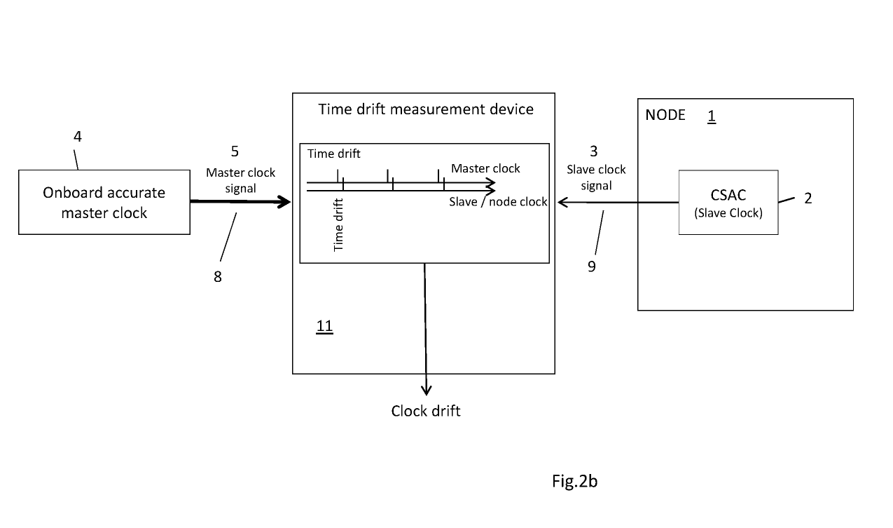

A typical procedure in the prior art for measuring time drift Δtᵢ on recovery is illustrated in FIGS. 2a and 2b. The procedure is as follows:
1. The seismic nodes 1 are connected to the vessel master clock 4 as the seismic nodes come onboard the vessel. The seismic nodes 1 may be temporarily connected or docked in a particular time drift station before being transported to the node storage area. Alternatively, the nodes may also be directly transported and connected to the master clock 4 in the node storage area. In this prior art method there will always be a practical limitation of how many seismic nodes that can be connected for time drift measurement at the same time. Today this is typically 8 to 32 seismic nodes.
2. As illustrated in FIG. 2a, the seismic node's internal slave clock 2 sends its internal slave clock synchronization signal 3 to the vessel master clock 4. The internal slave clock synchronization signal 3 may be sent to the master clock on a slave clock communication line 9. The vessel master clock 4 compares the slave clock synchronization signal 3 with its own master clock synchronization signal 5. This measurement of the time difference, Δtᵢ called time drift) is made available on an interface to a computer. An alternative embodiment is shown in FIG. 2b, where the internal slave clock synchronization signal 3 and the master clock synchronization signal 5 are both sent to a separate time drift measurement device 11 comparing the slave clock synchronization signal 3 with the master clock synchronization signal 5. The measurement of the time drift; Δtᵢ; is made available on an interface to the computer.
3. When the time drift of the slave clock in the connected seismic node 1 has been measured by the vessel master clock 4 (FIG. 2a), the master clock is disconnected from the connected seismic node to allow the next seismic node(s) to be connected. When the time drift has been measured by the time drift measurement device 11 (as in the alternative in FIG. 2b), the connected seismic node is disconnected from the central computer to allow the next seismic node (s) to be connected.

If the procedure explained above is performed when the seismic nodes are in their final storage position in e.g. a storage rack, this requires a communication line 9 from every seismic node and every storage position to the master clock. The node's slave clock sends its slave clock synchronization signal to the master clock on this cable. Normally, the slave clock communication line 9 is a different communication line than the master clock communication line 8 used to transmit the master clock synchronization and calibration signal before deployment. The slave clock communication line 9 thus comes in addition to the cable required for the master clock synchronization signal.

Alternatively, the same communication line may be used for both the slave clock signal and the master clock signal, but then switches need to be applied in both ends to allow transmission of either the master clock communication signal or the slave clock communication signal over the same communication line.

With many seismic nodes, these prior art solutions become a logistics challenge and the procedure is therefore often that the nodes are connected only until the time difference (time drift) is detected and then disconnected again. As explained earlier, a master clock can only be connected to a limited number of slave clocks and thus a limited number of seismic nodes, at the same time (normally up to 32). Using one communication line and switches adds complexity and time to the process, and do neither solve the problem of the limitation of how many seismic nodes that may be connected to the master clock at the same time. A further alternative prior art solution is after recovery of the seismic nodes from the sea to pass each seismic node by a particular time drift station onboard the vessel, where the seismic node is temporarily connected to the master clock, the slave clock synchronization signal transmitted to the master clock, and the time drift measured by the master clock. A particular time drift station also adds complexity to the system and do neither solve the problem of the limitation in the number of nodes that may be connected to the master clock at the same time.

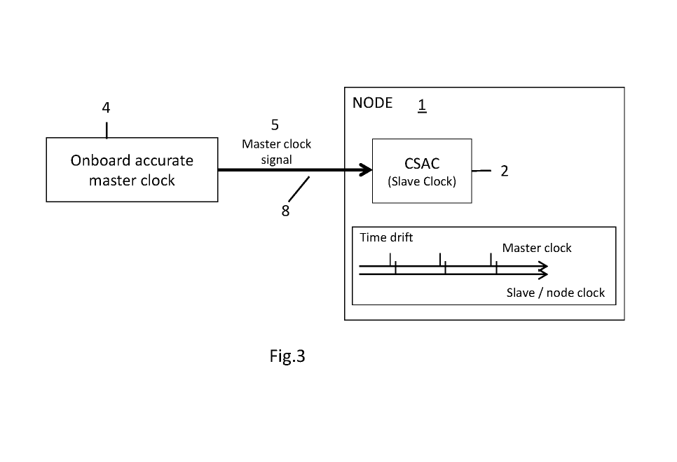

FIG. 3 illustrates a time drift measurement of an internal seismic node slave clock 3 according to an embodiment of the present invention. The time drift measurement is performed internally in the seismic node 1 after recovery of the seismic node from the sea. The measurement of time drift, (Δtᵢ,) is performed when the seismic node 1 is connected to the master clock 4. The slave clock in FIG. 3 is a Chip Scale Atomic Clock (CSAC), but other precision clocks may be used. The seismic node 1 receives the master clock signal 5 from the master clock 4, and obtains the time drift (Δtᵢ) between the slave clock signal and the signal from the master clock. The measurement of the time drift is thus performed in the node itself. The master clock signal may be a synchronization signal having accurate synchronization pulses. The accurate synchronization pulses may e.g. be a pulse at intervals of one second, but other pulse shapes and pulse intervals may also be used. The synchronization signal from the master clock may also be other forms of synchronization pulses or signals.

A typical drift for a slave clock in the seismic node may be around 2-5 milliseconds per 100 days.

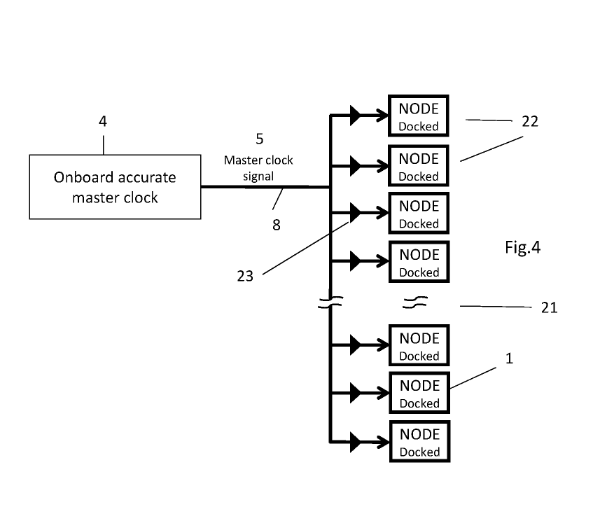

The example embodiment in FIG. 4 illustrates a number of seismic nodes 1 docked in their final docking positions 22 in the storage system 21 and connected to the master clock 4. All the seismic nodes are connected to the master clock upon docking. All the seismic nodes may thus be simultaneously connected and/or remain to be connected at the same time to the master clock. The measurement of the time drift in the seismic nodes is as explained above in FIG. 3. A driver or repeater 23 may be used to accomplish connection of the master clock 4 to all the seismic nodes. The driver or repeater ensures that the master clock synchronization signal is preserved during transmission from the master clock to the seismic nodes to enable accurate time drift measurements in all the seismic nodes. A driver or repeater 23 may be assigned to each storage position or a group of storage positions. Use of a driver or repeater is preferred when the master clock synchronization signal is in the form of accurate synchronization pulses. Use of a driver or repeater is also preferred for a system with a large number of seismic nodes.

The seismic node 1 may also be connected to the master clock before reaching its final storage position or docking position in the storage system. The final storage positions may be in a node storage system having a node storage area(s), a node storage rack(s) or node storage shelf/shelves. The connection to the master clock may be a cable based connection or a wireless connection.

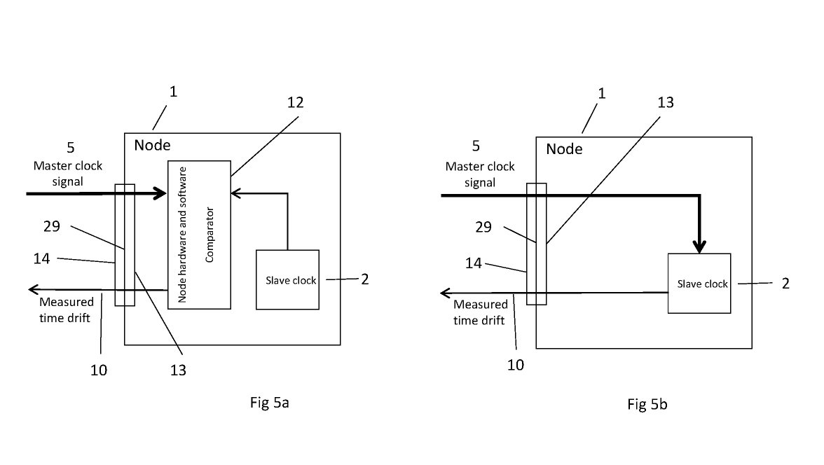

FIGS. 5a and 5b illustrates further embodiments of a seismic node 1 according to the invention. The seismic node in both FIGS. 5a and 5b is configured for internal clock drift measurement; i.e. the measurement of clock drift is performed internally in the seismic node itself. The seismic node comprises a slave clock 2 and an input for receiving the synchronization signal from the master clock. In the embodiments in FIG. 5a and FIG. 5b, the seismic node comprises a signal comparator 15. The signal comparator 15 is used for obtaining the time difference, and hence the time drift, between the slave clock 2 and the received signal from the master clock 4. The clock signal comparator 15 may be software and/or hardware. The clock signal comparator may be arranged as a separate component in the node as illustrated in FIG. 5a. The clock signal comparator 15 may alternatively be included in the slave clock 2 itself as illustrated in FIG. 5b. The comparator may be hardware and/or software to be run by a node processor.

The input for receiving the signal from the master clock may be provided in a seismic node connector 13 used for connecting the seismic node to the master clock. The seismic node may be connected to the master clock in a storage position. The storage position may be a docking station. The storage position/docking stations comprises a corresponding docking connector 14 for connecting to the seismic node connector 13. The seismic node connector and the docking connector may be provided with plugs or connecting devices for at least one of electrical connection, connectors for optical fibres or wireless communication. The seismic node connector may be designed as a common single node interface 29 with the docking connector 14. This common single node interface 29 may thus be the common interface with the seismic node handling system 20 onboard the vessel. The seismic node interface 29 may thus also provide an interface for e.g. the synchronization and calibration signals received from the master clock before deployment of the seismic nodes, for the signals received from the master clock after recovery of the seismic node, for data communication between a data management system and the seismic node, for transmission of the measured time drift, and for power and charging of the chargeable batteries in the nodes.

The seismic node may include a transceiver/transmitter for transmitting the measured time drift (Δtᵢ) to the data management system 25 or a central computer 26. The time drift may be also be transmitted by the separate comparator device 15 (FIG. 5a) or by the slave clock 3 (FIG. 5b). The measured time drift may be transmitted to a central computer via a cable, fibre optic cable or wirelessly.

An example embodiment of a seismic node handling system 20 for time drift measurement internally in the seismic nodes is illustrated in FIG. 6. The seismic node handling system comprises a master clock 4, and a time drift between a clock 2 in a seismic node 1 and the master clock is obtained by a time drift measurement internally in each seismic node as explained above. The time drift measurement may be performed after recovery of the seismic nodes. The seismic node handling system 20 comprises a seismic node storage system 21 comprising a plurality of storage positions 22 for seismic nodes 1. Each storage position 22 is adapted for receiving a seismic node. In FIG. 6 the storage positions where no seismic node has been docked, are shown as an empty station, and the storage positions where a seismic node has been docked are shown as node docked positions. When the seismic nodes are docked, the docking connector assigned to the particular storage position is connected to the seismic node connector. Docking of the seismic nodes in the storage positions may be performed manually, semi-automatic or automatic by e.g. a robotic system. The master clock may be calibrated and synchronized with satellite systems (e.g. GPS 24) or be a high precision atomic clock as explained earlier. The node handling system 20 in the embodiment in FIG. 6 comprises a specially assigned communication line 8 for transmitting the master clock signal 5 from the master clock 4 and to each seismic node docking position 22 in the seismic node storage system. In the embodiment in FIG. 6, a driver or repeater 23 is provided for each seismic node storage position. However, as explained above, use of a driver or repeater 23 is optional, and if used a driver or repeater need not be assigned to each storage position, but may be assigned to a group of storage positions. The measured time drift in each node slave clock 2 may be transmitted from each seismic node 1 and to the central computer 26 through the data communication line 28, eliminating the need for a separate transmission line for transmitting the slave clock synchronization signal to the master clock as in the prior art solutions.

The communication line for the master clock signal, the communication line for the time drift signal and any communication lines between the seismic nodes and the seismic node handling system may be a cable based communication line, a fibre optic based communication line or a wireless transmission. The cable connection may be a single line, an electrical cable, or a fibre optic cable. The wireless transmission may e.g. be optical transmission, radio broadcasting transmission, or RF transmission. The charging of batteries and any power transfer may be a cable based solution or a wireless solution. Wireless power transfer includes e.g. induction.

The seismic nodes may typically also include sensors, internal memory, processors and batteries as required for operation as a seismic node on the seabed. The sensors may e.g. include at least one of geophones, hydrophones, recorders, compasses, tilt sensors and transponders. The batteries may be non-rechargeable or rechargeable. If rechargeable batteries are used, a built in battery charger may also be included.

A procedure for measuring the slave clock drift after recovery of the seismic node from the sea may be as follows:

1. As the seismic nodes 1 come onboard the vessel, the seismic nodes are connected to the master clock 4. As explained earlier, the seismic nodes may be connected to the master clock in a position other than the final storage position of the seismic nodes or in the storage system. The seismic nodes may also be connected to the master clock upon docking in their assigned storage positions in the node storage system. Upon docking, the seismic node is connected to the master clock. Optionally, the seismic node may also upon docking be connected to at least one of the power, data and communication lines of the node handling system. The master clock 4 transmits the master clock signal 5 to all the seismic node positions or docking positions through a specially assigned master clock communication line 8. As each node receives the master clock synchronization signal 5 when docked or connected, the time drift can be measured as soon as the node is connected or docked upon recovery. The master clock signal is the same signal as used for calibration and synchronization of the slave clocks in the nodes before deployment.

2. The measurement of the slave clock drift between the slave clock signal and the master clock signal is performed in the nodes themselves by software and/or hardware in each node.

3. Each node 1 transmits the measured time-drift via the data communication line or a separate time drift communication line 10 to the data management system (DMS) 25 or the central computer 26 onboard the vessel.

4. The recorded data in each node are normally corrected for clock drift. As the measurement of the time drift is performed in the seismic node, the correction of recorded data may be performed in each node before or during downloading of the recorded data from the node to a central computer. Alternatively, the correction of recorded data may also be performed after the recorded data has been downloaded from the seismic node to the central computer as in the prior art solutions. The recorded data are stored on data storage mediums 27, e.g. tapes or discs.

As the measurement of clock drift is performed internally in each node, each node does not need to be passed to a particular clock drift station before deployment or after recovery before parking the node in its final storage position in the node storage rack. The nodes may be transported straight into their assigned docking station in the node storage rack once recovered from the sea onboard the vessel. The slave clock signal from each node does neither need to be transmitted from each node to the master clock on the vessel as in the prior art solutions. This also avoids use of a separate slave clock communication line from each node to the master clock, and also avoids a further output from the slave clock itself for transmission of the slave clock synchronization signal to the master clock. By not having to connect the slave clock's synchronization signal to the master clock, this allows an unlimited number of slave clocks, and thus an unlimited number of nodes to be connected to the master clock for time drift measurement at any time.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1-26. (canceled)

27. Method for time drift measurement of at least one slave clock in at least one seismic node, wherein the time drift measurement is performed in the at least one seismic node, the method further comprising receiving a master clock signal in each seismic node, and obtaining in each seismic node the time drift between the slave clock and the received master clock signal.

28. Method according to claim 27, wherein the obtained time drift is transmitted from each seismic node and to a computer or data management system.

29. Method according to claim 27, wherein the time drift is transmitted over a cable, an optical fibre, or wirelessly.

30. Method according to claim 27, wherein the time drift measurement is performed in the at least one slave clock in the seismic node, in a processor in the seismic node or in a hardware and/or software component in the seismic node.

31. Method according to claim 27, wherein the time drift is measured when the seismic node is in a storage position.

32. Method according to claim 27, wherein recorded data in the seismic node is corrected for time drift before or during downloading of the recorded data from the seismic node and to a central computer.

33. Method according to claim 27, wherein the master clock signal and the slave clock signal are time synchronization signals.

34. A seismic node comprising:
a slave clock;
wherein the seismic node is configured for receiving a master clock signal and obtaining a time drift between the slave clock and the master clock signal.

35. Seismic node according to claim 34, further comprising:
a clock signal comparator for obtaining the time drift between the slave clock and the master clock signal.

36. Seismic node according to claim 35, wherein the clock signal comparator is hardware and/or software.

37. Seismic node according to claim 35, wherein the clock signal comparator is included in the slave clock.

38. Seismic node according to claim 34, further comprising:
a connector providing a seismic node interface for at least one of power transmission, communication signals, data transmission, the master clock signal or a measured time drift signal.

39. Seismic node according to claim 34, further comprising:
a transceiver/transmitter for transmitting the measured time drift to a central computer or a data management system.

40. Seismic node according to claim 34, wherein the measured time drift is transmitted via a cable, a fibre optic cable or a wireless transmission.

41. Seismic node according to claim 40, wherein wireless transmission comprising at least one of optical transmission, radio broadcasting transmission, or RF transmission.

42. Handling system for seismic nodes, the handling system comprising:
a seismic node storage system comprising a plurality of storage positions for the seismic nodes; and
a master clock, and wherein a time drift between a slave clock in a seismic node and the master clock is obtained by a time drift measurement internally in each seismic node, and wherein each seismic node is configured for receiving a master clock signal from the master clock.

43. Handling system according to claim 42, further comprising a communication line for transmitting the master clock signal to each seismic node.

44. Handling system according to claim 42, wherein the communication line comprising repeaters and/or drivers for the master clock signal.

45. Handling system according to claim 42, wherein the time drift in a seismic node is measured when the seismic node is in a storage position.

46. Handling system according to claim 45, wherein at least one of a signal repeater and a driver is assigned to each seismic node storage position or a group of seismic node storage positions.

47. Handling system according to claim 42, wherein each seismic node comprises a connector providing a seismic node interface for at least one of power transmission, communication signals, data signals, a master clock signal or a time drift signal.

48. Handling system according to claim 46, wherein each seismic node storage position is provided with a docking connector for connecting to the connector on the seismic node.

49. Handling system according to claim 42, wherein the measured time drift is transmitted from each seismic node and to a central computer or a data management system through a communication line.

50. Handling system according to claim 42, wherein recorded data in the seismic nodes are corrected for time drift before or during downloading of the recorded data from the seismic nodes and to a central computer or a data management system.

51. Handling system according to claim 44, wherein the communication line may be a cable based communication line, a fibre optic based communication line or a wireless transmission.
